(19) United States
(12) Patent Application Publication
(10) Pub. No.: US 2026/0046698 A1
(43) Pub. Date: Feb. 12, 2026

(54) PACKET DATA CONVERGENCE PROTOCOL TIMER CONFIGURATIONS

(71) Applicant: Lenovo (Singapore) Pte. Limited, Singapore (SG)

(72) Inventors: Joachim Löhr, Wiesbaden (DE); Shwetha Sreejith, Steinbach (DE); Prateek Basu Mallick, Dreieich (DE)

(73) Assignee: Lenovo (Singapore) Pte. Limited, Singapore (SG)

(21) Appl. No.: 18/798,599

(22) Filed: Aug. 8, 2024

(51) Int. Cl. H04W 28/16; H04W 28/10; H04W 76/38

(52) U.S. Cl. CPC H04W 28/16; H04W 28/10; H04W 76/38

(57) ABSTRACT

Various aspects of the present disclosure relate to packet data convergence protocol (PDCP) configurations. An apparatus, such as a UE, receives a configuration for a PDCP entity of the UE, where the configuration includes a set of timer configurations and a set of identifiers associated with the set of timer configurations. The UE receives a SDU at the PDCP entity of the UE, and starts a timer associated with the PDCP entity of the UE and in accordance with a timer configuration, where the timer configuration is applicable for the received SDU based at least in part on a corresponding identifier of the timer configuration and a respective identifier the received SDU.

### TECHNICAL FIELD

The present disclosure relates to wireless communications, and more specifically to data packet management in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling. A network entity, for instance, can be implemented via a NE.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive (e.g., obtain, acquire) a configuration for a packet data convergence protocol (PDCP) entity of the UE, wherein the configuration includes a set of timer configurations and a set of identifiers associated with the set of timer configurations; receive (e.g., obtain, acquire) a service data unit (SDU) at the PDCP entity of the UE; and start (e.g., activate, trigger, initiate) a timer associated with the PDCP entity of the UE and in accordance with a timer configuration, wherein the timer configuration is applicable for the received SDU based at least in part on a corresponding identifier of the timer configuration and a respective identifier of the received SDU.

In some implementations of the method and apparatuses described herein, the at least one processor is configured to cause the UE to receive the configuration from a radio access network (RAN); the at least one processor is configured to cause the UE to select the timer configuration based at least in part on a mapping between the corresponding identifier of the timer configuration and the respective identifier of the received SDU; a value for the timer is based at least in part on the selected timer configuration; the set of identifiers includes a set of quality of service (QoS) flow identifiers; the at least one processor is configured to cause the UE to start the timer in response to the received SDU; the timer includes a PDCP discard timer; the respective identifier of the received SDU includes a QoS flow identifier of a QoS flow associated with the received SDU; each timer configuration of the set of timer configurations is associated with a respective QoS flow; the timer configuration is applicable for the received SDU further based at least in part on a priority associated with the received SDU; the set of identifiers is associated with a set of radio link control (RLC) entities of the UE associated with the PDCP entity, and wherein the at least one processor is configured to cause the UE to: route a protocol data unit (PDU) associated with the received SDU to a respective RLC entity of the UE based at least in part on a respective identifier associated with the respective RLC entity and the respective identifier associated with the received SDU.

Some implementations of the method and apparatuses described herein may further include a processor for wireless communication to receive a configuration for a PDCP entity of a UE, wherein the configuration includes a set of timer configurations and a set of identifiers associated with the set of timer configurations; receive a SDU at the PDCP entity of the UE; and start a timer associated with the PDCP entity of the UE and in accordance with a timer configuration, wherein the timer configuration is applicable for the received SDU based at least in part on a corresponding identifier of the timer configuration and a respective identifier the received SDU.

Some implementations of the method and apparatuses described herein may further include a method performed by a UE, the method including receiving a configuration for a PDCP entity of the UE, wherein the configuration includes a set of timer configurations and a set of identifiers associated with the set of timer configurations; receiving a SDU at the PDCP entity of the UE; and starting a timer associated with the PDCP entity of the UE and in accordance with a timer configuration, wherein the timer configuration is applicable for the received SDU based at least in part on a corresponding identifier of the timer configuration and a respective identifier the received SDU.

In some implementations of the method and apparatuses for a UE described herein, the method further comprising receiving the configuration from a radio access network (RAN); selecting the timer configuration based at least in part on a mapping between the corresponding identifier of the timer configuration and the respective identifier of the received SDU; wherein a value for the timer is based at least in part on the selected timer configuration; wherein the set of identifiers includes a set of QoS flow identifiers; starting (e.g., activating, triggering, initiating) the timer in response to the received SDU; wherein the timer includes a PDCP discard timer; wherein the respective identifier of the received SDU includes a QoS flow identifier of a QoS flow associated with the received SDU; wherein each timer configuration of the set of timer configurations is associated with a respective QoS flow; wherein the timer configuration is applicable for the received SDU further based at least in part on a priority associated with the received SDU; wherein the set of identifiers is associated with a set of radio link control (RLC) entities of the UE associated with the PDCP entity, and wherein the method further includes routing a PDU associated with the received SDU to a respective RLC entity of the UE based at least in part on a respective identifier associated with the respective RLC entity and the respective identifier associated with the received SDU.

Some implementations of the method and apparatuses described herein may further include a NE for wireless communication to transmit (e.g., send, communicate) a configuration for a PDCP entity of a UE, wherein the configuration includes a set of timer configurations and a set of identifiers associated with the set of timer configurations.

In some implementations of the method and apparatuses for a NE described herein, the configuration further includes a mapping between each timer configuration and each different respective identifier of the set of identifiers; the set of identifiers includes quality of service flow identifiers; each timer configuration of the set of timer configurations is associated with a respective timer value; one or more timer configurations of the set of timer configurations include PDCP discard timer configurations; each timer configuration of the set of timer configurations is associated with a different respective quality of service flow; the configuration further includes importance level information for each timer configuration of the set of timer configurations.

Some implementations of the method and apparatuses described herein may further include a method performed by a NE, the method including transmitting (e.g., sending, communicating) a configuration for a PDCP entity of a UE, wherein the configuration includes a set of timer configurations and a set of identifiers associated with the set of timer configurations.

In some implementations of the method and apparatuses for a NE described herein, where the configuration further includes a mapping between each timer configuration and each different respective identifier of the set of identifiers; the set of identifiers includes quality of service flow identifiers; each timer configuration of the set of timer configurations is associated with a respective timer value; one or more timer configurations of the set of timer configurations include PDCP discard timer configurations; each timer configuration of the set of timer configurations is associated with a different respective quality of service flow; the configuration further includes importance level information for each timer configuration of the set of timer configuration.

### BRIEF DESCRIPTION OF THE DRAWINGS

FIG. 1 illustrates an example of a wireless communications system in accordance with aspects of the present disclosure.

FIG. 2 illustrates an example of a system for multimodal traffic.

FIG. 3 illustrates a scenario where multiple QoS flows are multiplexed into a same radio bearer.

FIGS. 4-8 illustrate an example information element in accordance with aspects of the present disclosure.

FIGS. 9-13 illustrate an example information element in accordance with aspects of the present disclosure.

FIG. 14 illustrates a scenario where different QoS flows are split into different RLC entities in accordance with aspects of the present disclosure.

FIG. 15 illustrates an example of a UE in accordance with aspects of the present disclosure.

FIG. 16 illustrates an example of a processor in accordance with aspects of the present disclosure.

FIG. 17 illustrates an example of a NE in accordance with aspects of the present disclosure.

FIG. 18 illustrates a flowchart of a method in accordance with aspects of the present disclosure.

FIG. 19 illustrates a flowchart of a method in accordance with aspects of the present disclosure.

### DETAILED DESCRIPTION

In a wireless communications system, a UE and a NE (e.g., a base station, gNB) may support wireless communication (e.g., reception and/or transmission of wireless communication) using time-frequency resources. In some cases, the wireless communications system can be configured to support various data traffic types, services, and/or applications using time-frequency resources. In some cases, the data traffic types, services, and/or applications may be related to one or more immersive technologies, such as extended reality (XR) (e.g., virtual reality (VR), augmented reality (AR), and/or mixed reality (MR)). A UE (e.g., a smartphone, smart glasses, tablet, and/or a headset) and a NE that support immersive technologies can be configured to handle (e.g., process) multiple simultaneous traffic flows, where a synchronization of an arrival of packets may be required to support and delivery an immersive experience. For example, immersive applications, such as XR can involve multimodal data such as voice data, video data, audio data, sensor data (e.g., haptic data), etc., to enable integrating human perception (e.g., human senses) in an XR experience. However, these multimodal data flows can involve stringent end-to-end latency, jitter, and synchronization parameters on the multimodal data and related multimodal data flows. Additionally, these immersive applications may have even more stringent requirements on the wireless communications system (e.g., wireless networks) because data flows, such as XR data flows may demand precise synchronization of multiple data flows.

When establishing enhancements for a wireless communications system supporting immersive technologies (e.g., XR applications), it may be desirable to consider multimodal interaction techniques. These techniques may accommodate multimodal data flows that process (e.g., handle) multiple human senses simultaneously. Multimodal interaction can transform how people interact remotely, practice tasks, entertain themselves, process information (e.g., visualizations), and make decisions based on the provided information. For immersive technologies, such as XR applications that involve multimodal data transmitted via a cellular communication system (e.g., NR), it might be important to consider the interactions between different input signals. This includes the interdependencies between transmissions of various bearers, logical channels (LCHs), data flows (e.g., PDU set level QoS requirements), and the dependencies among different QoS flows for XR. In some cases, due to the separate handling of multiple media components for XR, synchronization between these components might be crucial to avoid negatively impacting the XR experience (i.e., user experience). For instance, an increase in asynchrony between different modalities can decrease users' sense of presence and realism in the XR experience.

Aspects of the present disclosure are described in the context of a wireless communications system and further describe implementations that enable the wireless communications system (e.g., a UE, a NE (e.g., a base station, gNB), and/or other network entities) to handle packets associated with different QoS flows, where packets associated with the different QoS flows can be multiplexed to a same radio bearer. A network entity may configure multiple PDCP discardTimer with each of the PDCP discardTimer being mapped to data of a certain QoS flow, PDCP SDUs can be efficiently discarded, for example, by a UE according to a packet delay budget (PDB)/PDU set delay budget (PSDB) associated with each of the PDCP SDUs. For instance, the network entity may configure a PDCP entity of the UE with a set of multiple PDCP discardTimers for each of the QoS flows multiplexed to the radio bearer/PDCP entity.

For example, in some implementations, the network entity configures a set of one or more PDCP discardTimers for a PDPC entity of the UE, and each of the one or more configured PDCP discardtimers can be applied for a PDCP SDU of a PDU set associated with a predefined criterion. Further, different PDCP discardTimer configurations can be used for different PDU sets of a data radio bearer (DRB)/PDCP entity of the UE being associated with different QoS flows. A DRB, for instance, represents a logical connection between a UE and the gNB and defines a set of radio frequency resources and QoS parameters for carrying (e.g., transmitting, receiving) user data and control information. A mapping between a PDCP discardTimer of a set of one or more PDCP discardTimers and a QoS flow identifier (QFI) can be configured and/or specified by the network entity.

In some implementations, the network entity configures multiple sets of multiple PDCP discardTimers for a PDPC entity of the UE, where each of the set of configured PDCP discardtimers can be applied for a PDCP SDU of a PDU set associated with predefined criteria. Additionally, for each QoS flow mapped to a radio bearer/PDCP entity, a set of multiple PDCP discardTimer configurations can be configured. For each QoS flow identified by a QFI, two PDCP discardTimers can be configured (e.g., discardTimer and discardTimerForLowImportance).

By performing the described techniques herein, QoS across multiple data flows can be increased while decreasing signaling overhead and network congestion.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

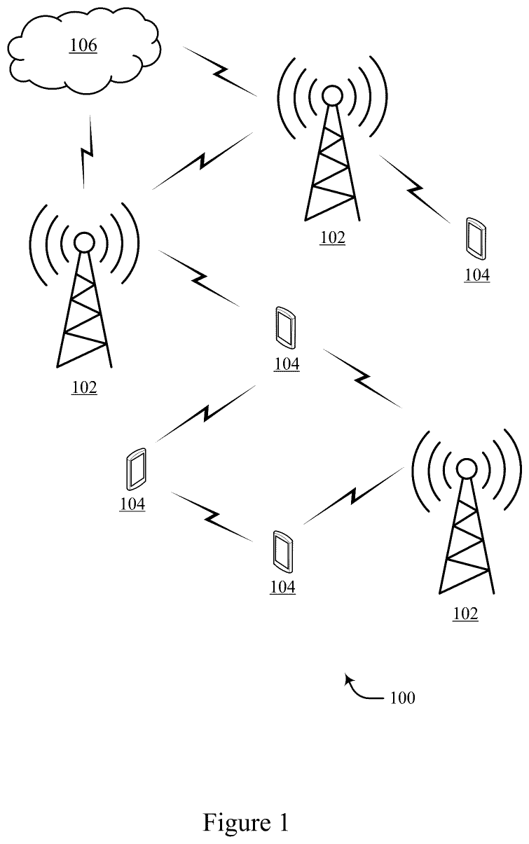

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It is to be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 receives, from a NE 102, a configuration for a PDCP entity of the UE, where the configuration includes a set of timer configurations and a set of identifiers associated with the set of timer configurations. The UE 104 receives, a SDU at the PDCP entity of the UE from higher layer. The UE 104 then starts a timer associated with the PDCP entity of the UE and in accordance with a timer configuration, wherein the timer configuration is applicable for the received SDU based at least in part on a corresponding identifier of the timer configuration and a respective identifier of the received SDU.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

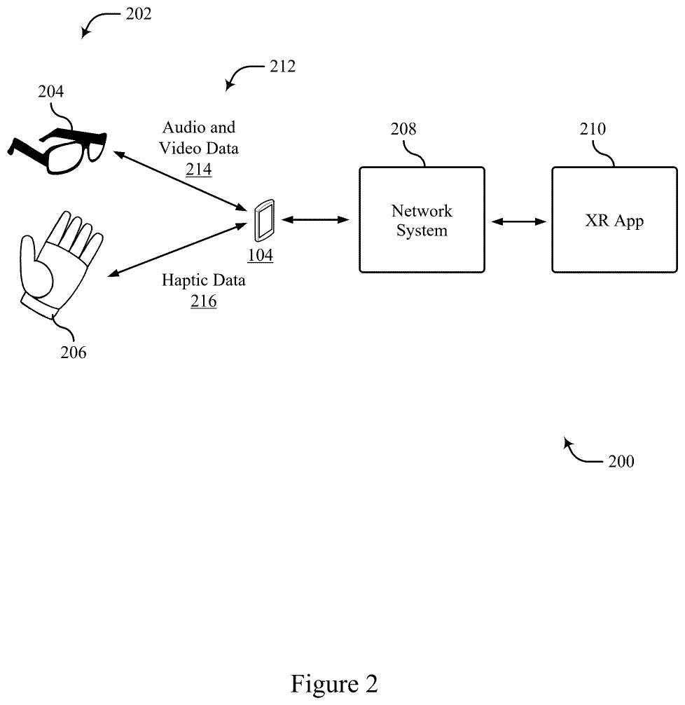

FIG. 2 illustrates an example of a system 200 for multimodal traffic. The system 200 includes XR devices 202, which in this example includes augmented reality (AR) glasses 204 and a haptic glove 206. The XR devices 202 are connected to a UE 104. Further, the UE 104 is connected to a network system 208 to enable connectivity to an XR application 210. The network system 208 can be implemented in various ways, such as a 3GPP system including 4G, 5G, 6G, and beyond. In the system 200, the XR devices 202 and the UE 104 can exchange multimodal XR traffic 212 with the XR application 210 including, in this example, audio and video data 214 and haptic data 216.

With reference to wireless communications and particularly XR communications, due to the separate handling of the multiple media components, synchronization between different media components is critical in order to avoid having a negative impact on the user experience. As the asynchrony between different modalities increases, users' sense of presence and realism will decrease. Table 1 below from 3GPP Technical Specification (TS) 22.847 (Table 5.1.6-2) depicts synchronization thresholds between two or more modalities.

TABLE 1
Typical synchronization thresholds for
immersive multi-modal VR applications

synchronization threshold (note 1)

| | | |
|---|---|---|
| audio-tactile | audio delay: | tactile delay: |
| | 50 ms | 25 ms |
| visual-tactile | visual delay: | tactile delay: |
| | 15 ms | 50 ms |

NOTE 1:
For each media component, “delay” refers to the case where that media component is delayed compared to the other.

In XR communications, the synchronization requirements between the modalities and the related inter-dependencies among different transmissions/LCHs pose new challenges for an efficient support. For an XR application, haptic/sensor data, video, and audio data may need to be delivered within a small relative delay. In addition, each of the data streams (video, sensor, etc.) are to be delivered within its latency budget. A delay status report (DSR) can be triggered enabling gNB to assign resources to an un-delivered traffic flow getting close to its latency budget. It is to be noted that the different streams/modalities of a XR Multi-Modal application (e.g. audio, video, haptics) may have different QoS requirements, as for example shown in Table 2 below, Table 5.7.3-1 from TS22-847.

TABLE 2
Typical QoS requirements for multi-modal streams

| | Haptics | Video | Audio |
|---|---|---|---|
| Jitter (ms) | ≤2 | ≤30 | ≤30 |
| Delay (ms) | ≤50 | ≤400 | ≤150 |
| Packet loss (%) | ≤10 | ≤1 | ≤1 |
| Update rate (Hz) | ≥1000 | ≥30 | ≥50 |
| Packet size (bytes) | 64-128 | ≤MTU | 160-320 |
| Throughput (kbit/s) | 512-1024 | 2500-40000 | 64-128 |

Regarding DSR enhancements, an NE (e.g., gNB) can take information of PDU set delay into account in scheduling transmissions, e.g., by giving priority to transmissions close to their delay budget limit, and by not scheduling (e.g., uplink (UL)) transmissions exceeding a PDU set delay budget. The UE can also utilize such information to save UE power by determining if an UL transmission e.g., UL pose, or physical uplink shared channel (PUSCH)) corresponding to a transmission that exceeds its delay budget can be dropped. Additionally, a UE does not need to wait for re-transmission of a physical downlink shared channel (PDSCH) that will likely not occur (e.g., discontinuous reception (DRX) retransmission timers can be stopped). For downlink (DL) transmissions it can be assumed that an NE is aware of the remaining delay budget of the data pending for transmission (e.g., based on information provided by the session management function (SMF)) and the NE can utilize such information for scheduling decisions.

For UL resource allocation, a UE can provide assistance information regarding the remaining delay budget of the data pending in its buffer to the NE. It was agreed that the UE provides information on the remaining delay budget of the data for which UL resources are requested. Such assistance information is referred to as DSR reporting. The PSDB information provided to the RAN may not be sufficient. The network may not be aware of the exact arrival time of UL data in the buffer and hence may also not determine the remaining (valid) time of data being pending in the buffer for transmission. Accordingly, the UE can provide this information (e.g. remaining delay information) within the DSR reporting. It has been agreed that a new (DSR) medium access control (MAC) control element (CE) is introduced for XR-specific logical channel groups (LCGs) which includes the amount of data available for transmission and some remaining delay information associated with the data reported. Furthermore, it has been agreed that threshold based DSR reporting is supported, e.g., DSR reporting is triggered when remaining delay of a PDU/PDU set is below a network entity configured threshold. The threshold can be configured per LCG.

Regarding PDU set importance level (PSI)-based discarding, in RAN2 #121 it was agreed that PSI can be considered for PDU set discarding in the presence of UL congestion. Therefore, in addition to the timer-based discard mechanism within a given PDCP entity, a PDCP discarding mechanism based on PSI is introduced for XR communications. The detailed discarding mechanism based on the importance level (PSI) of a PDU set in the case of congestion has been initially discussed in RAN2 #122. For instance, the network entity controls the PSI-based discarding at the UE at the presence of congestion. To be more specific, the network entity explicitly instructs the UE to enable/disable PSI-based PDCP discarding (e.g. network entity enables/disables PSI-based discarding) based on a detected congestion. The network entity can be responsible for the detection of congestion and UE acts based the network entity signaling. The agreed mechanism for PSI-based discarding at the Tx side is a mechanism where the UE is configured with two PDCP discard timer configurations, e.g., discardTimer and discardTimerForLowImportance. If the network entity enables PSI-based discarding (e.g., in the event of a detected congestion), the UE/PDCP applies the second PDCP discard timer (discardTimerForLowImportance) for low importance PDU sets, e.g., a new timer is started upon reception of an SDU belonging to a low importance PDU set.

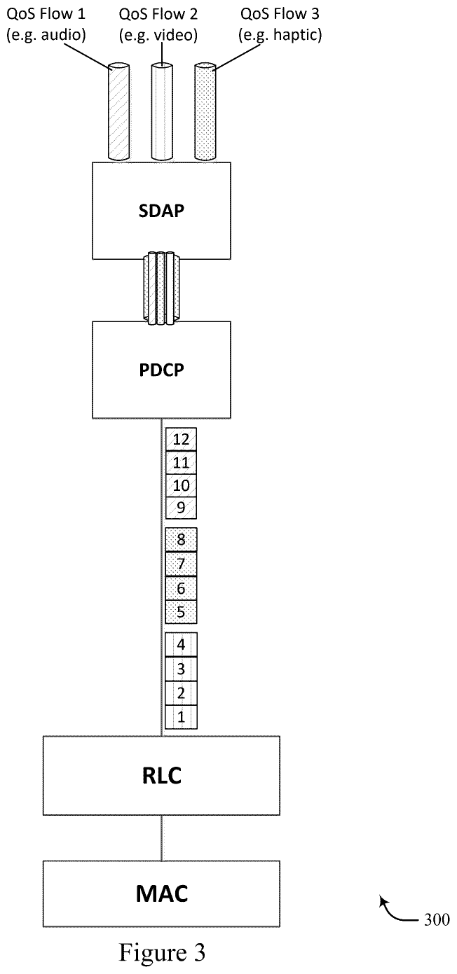

FIG. 3 illustrates a scenario 300 where multiple QoS flows are multiplexed into a same radio bearer. For instance, in the scenario 300 three different QoS flows (QoS Flow 1, QoS Flow 2, QoS Flow 3) belonging to one multimodal (MM) service are multiplexed to the same radio bearer. Accordingly, for an XR multi-modal application, haptic/sensor data, video, and audio data may need to be delivered within a small relative delay. In addition, each of the data streams (video, sensor, etc.) are to be delivered within its latency budget. In order to address the strict synchronization requirements among the different modals, one option is to multiplex data flows belonging to a same multi-modal service (e.g., video, audio, and haptic flows of an MM application) to the same radio bearer.

When multiplexing QoS flows with distinct QoS requirements on the same radio bearer, there are certain challenges/problems which need to be specifically addressed for an efficient support on the air interface. One issue is the handling of the PDCP discardTimer for an PDCP entity/radio bearer carrying data of QoS flows having different QoS/delay requirements. As shown in Table 2 above haptic traffic has a much shorter delay requirement than video traffic for example. Using the same PDCP discardTimer for a radio bearer carrying haptic data as well as video data can be very inefficient, e.g. typically the discardTimer is configured in accordance with the PDB/PSDB of a service. It is to be noted that according to current specifications only one PDCP discardTimer is configured per PDCP entity, e.g. not considering PSI-based discarding functionality introduced for XR. Furthermore, packets of a radio bearer are, according to current specifications, treated with the same QoS over the air interface, e.g. some packet error rate is targeted. Accordingly, the present disclosure provides several solutions which allow a distinct treatment of packets from different QoS flows multiplexed to the same radio bearer.

XR can be used as an umbrella term for different scenarios such as virtual reality (VR), AR, and mixed reality (MR). VR, for instance, represents a rendered version of a delivered visual and audio scene. The rendering can be designed to naturally mimic visual and audio sensory stimuli of the real world to an observer and/or user as they move within the limits defined by an application. VR can involve a user wearing a head mounted display (HMD) to replace the user's field of view with a simulated visual component and headphones to provide the user with accompanying audio. Head and motion tracking of the user in VR can also be utilized to allow the simulated visual and audio components to be updated to enable that, from a user perspective, objects and sound sources remain consistent with the user's movements.

AR can represent scenarios where a user is provided with additional information, artificially generated items, and/or content overlaid upon their current real world environment. Such additional information and/or content can be visual and/or audible and the user's observation of their current environment may be direct (e.g., with no intermediate sensing, processing, and/or rendering) or indirect, e.g., where the user's perception of their environment is relayed via sensors and may be enhanced and/or processed. MR can represent an advanced form of AR where some virtual elements are inserted into the physical scene with the intent to provide the illusion that these elements are part of a real scene.

Accordingly, XR can refer to real-and-virtual combined environments and human-machine interactions generated by computer technology and wearables. XR can include representative forms such as AR, MR and VR and areas interpolated among them. The levels of virtuality can range from partially sensory inputs to fully immersive VR. One aspect of XR is the extension of human experiences especially relating to the senses of existence (e.g., represented by VR) and the acquisition of cognition, e.g., represented by AR.

XR and cloud gaming use cases can be characterized by quasi-periodic traffic (with possible jitter) with high data rate in DL (e.g., video steam) combined with the frequent Uplink (UL) (e.g., user pose and/or control update) and/or UL video stream. Both DL and UL traffic in such scenarios can be characterized by relatively strict PDB.

In such scenarios a set of XR and cloud gaming services has a variety and characteristics of data streams (e.g., video) that may change “on-the-fly”, such as while the services are running over a wireless communications systems, e.g., NR. Therefore, additional information on the running services from higher layers (e.g. the QoS flow association, frame-level QoS, PDU set-based QoS, XR specific QoS, etc.) may be beneficial to facilitate informed choices of radio parameters. XR application awareness by UE and gNB, for instance, may improve the user experience, improve the NR system capacity in supporting XR services, and reduce the UE power consumption.

An Application Data Unit (ADU) or PDU set may represent a smallest unit of data that can be processed independently by an application, such as processing for handling out-of-order traffic data. A video frame can be an intra-frame (I-frame), predicted frame (P-frame), can be composed of I-slices and/or P-slices, etc. I-frames and/or I-slices can be more important and larger than P-frames and/or P-slices. A PDU set can be one or more I-slices, P-slices, I-frame, P-frame, or a combination thereof.

A service-oriented design can consider XR traffic characteristics. Examples of XR traffic characteristics include variable packet arrival rate (e.g., packets arriving at 30-120 frames per second (fps) with some jitter), packets having variable and large packet size, bi-directional frames (B-frames) and/or predictive frames (P-frames) being dependent on I-frames, presence of multiple traffic and/data flows such as pose and video scene in uplink, etc. Such service-oriented designs can enable more efficient XR service delivery, such as for satisfying XR service parameters for a greater number of UEs and/or for UE power saving.

Latency parameters for XR traffic on the RAN side (e.g., air interface) can be modelled as PDB. The PDB is a limited time budget for a packet to be transmitted over the air from a NE to a UE. For a given packet, the delay of the packet incurred in air interface is measured from the time that the packet arrives at the NE to the time that it is successfully transferred to the UE. If the delay is larger than a given PDB for the packet, then the packet can be considered to violate PDB, otherwise the packet can be considered to be successfully delivered. The value of PDB may vary for different applications and traffic types, which can be 10-20 ms depending on the application.

In scenarios, arrival time of data bursts on the DL can be quasi periodic, e.g., periodic with jitter. Some of the factors leading to jitter in burst arrival include varying server render time, encoder time, Real-time Transport Protocol (RTP) packetization time, link between server and 5G gateway, etc. 3GPP agreed simulation assumptions for XR evaluation model DL traffic arrival jitter using truncated Gaussian distribution with mean include: 0 ms, std. dev: 2 ms, range: [−4 ms, 4 ms] (baseline), [−5 ms, 5 ms] (optional).

Applications can have a certain delay parameter on a PDU set that may not be adequately translated into packet delay budget requirements. For example, if the PSDB is 10 ms, then PDB can be set to 10 ms if all packets of the PDU set arrive at the wireless communications system at the same time. If the packets are spread out, then the PDU set delay budget can be measured either in terms of the arrival of the first packet of the PDU set or the last packet of the PDU set. In either case, a given PSDB can result in different PDB requirements on different packets of the PDU set. It is observed that specifying the PSDB to the wireless network system can be beneficial.

Regarding delay-aware communication, if a scheduler and/or the UE is aware of delay budgets for a packet/ADU, the NE can utilize this information for scheduling transmissions. The NE, for instance, can give priority to transmissions close to their delay budget limit and/or not schedule transmissions, e.g., UL. The UE can also utilize such information such as to determine if an UL transmission (e.g., Physical Uplink Control Channel (PUCCH) in response to PDSCH, UL user pose information, or PUSCH) corresponding to a transmission that exceeds its delay budget can be dropped (additionally, no requirement to wait for re-transmission of a PDSCH and no requirement to keep the erroneously received PDSCH in buffer for soft combining with a re-transmission that never occurs) and/or how much of the UE channel occupancy time in cases of unlicensed spectrum usage can be shared with the NE.

Remaining delay budget for a DL transmission can be indicated to the UE in a downlink control element (DCI) (e.g., for a packet of a video frame, slice, and/or ADU) or via a MAC-CE (e.g., for an ADU, video frame, and/or video slice) and for an UL transmission can be indicated to the NE via an UL transmission such as Uplink Control Information (UCI), PUSCH transmission, etc.

XR application awareness can be based on QoS flows, PDU Sets, data bursts, and traffic assistance information. To enable PDU Sets based QoS handling, PDU Set QoS parameters may be provided by the SMF to the NE as part of the QoS profile of the QoS flow. Examples of PDU Set QoS parameters include PSDB, PDU Set Error Rate (PSER), and PDU Set Integrated Handling Information (PSIHI). PSDB (such as defined in 3GPP Technical Specification (TS) 23.501) can represent an upper bound for the duration between the reception time of the first PDU (e.g., at the UPF for DL, at the UE for UL) and the time when all PDUs of a PDU Set have been successfully received, e.g., at the UE in DL, at the UPF in UL. A QoS Flow may be associated with only one PSDB, and when available, it applies to both DL and UL and supersedes the PDB of the QoS flow. The Access Network (AN) PSDB can be derived by subtracting the CN PDB from the PSDB.

PSER (such as defined in TS 23.501) can represent an upper bound for a rate of non-congestion related PDU Set losses between RAN and the UE. A QoS Flow may be associated with only one PSER, and when available, can apply to both DL and UL and supersedes the Packet Error Rate (PER) of the QoS flow. A PDU set, for instance, is considered as successfully delivered when all PDUs of a PDU Set are delivered successfully. PSIHI can indicate whether all PDUs of the PDU Set are needed for the usage of PDU Set by application layer, as defined in TS 23.501. The PDU Set QoS parameters can be common for all PDU Sets within a QoS flow.

Further, the UPF can identify PDUs that belong to PDU Sets, and may determine the following PDU Set Information which it sends to the gNB in the General Packet Radio Service Tunneling Protocol-User Plane (GTP-U) header: PDU Set Sequence Number; Indication of End PDU of the PDU Set; PDU Sequence Number within a PDU Set; PDU Set Size in bytes; and PSI, which identifies the relative importance of a PDU Set compared to other PDU Sets within the same QoS Flow.

Traffic assistance information may also be provided by a core network to the NE, such as: Via Time Sensitive Communication Assistance Information (TSCAI) (for both Guaranteed Bit Rate (GBR) and non-GBR QoS flows) (e.g., UL and/or DL Periodicity; N6 Jitter Information (i.e. between UPF and Data Network) associated with the DL Periodicity); and Indication of End of Data Burst in the GTP-U header of the last PDU in DL. In the UL, the UE may identify PDU Sets and Data Bursts dynamically, including PSI.

Regarding jitter aspects associated with XR, packet arrival rate can be determined by the frame generation rate, e.g., 60 fps. Accordingly, the average packet arrival periodicity can be given by the inverse of the frame rate, e.g., 16.6667 ms= 1/60 fps. The periodic arrival without jitter gives the arrival time at NE for packet with index k (=1, 2, 3 . . . ) as k/F*1000 [ms], where F is the given frame generation rates per second. The periodic packet arrival can implicitly assume fixed delay contributed from network side including fixed video encoding time, fixed network transfer delay, etc. However, in a real system, the varying frame encoding delay and network transfer time can introduce jitter in packet arrival time at gNB. In this model, the jitter can be modeled as a random variable added on top of periodic arrivals. The jitter can follow truncated Gaussian distribution with example statistical parameters illustrated in Table 3 below.

TABLE 3
Statistical parameters for jitter

| | | Baseline value | Optional value |
|---|---|---|---|
| Parameter | unit | for evaluation | for evaluation |
| Mean | ms | 0 | |
| Standard | ms | 2 | |
| Truncation range | ms | [−4, 4] | [−5, 5] |

Note that the given parameter values and considered frame generation rates (e.g., 60 or 120) can ensure that packet arrivals are in order, e.g., arrival time of a next packet can be larger than that of the previous packet. Thus, the periodic arrival with jitter gives the arrival time for packet with index k (=1, 2, 3 . . . ) as: offset+k/F*1000+J [ms], where F is the given frame generation rates (per second) and J is a random variable capturing jitter. Note that actual traffic arrival timing of traffic for each UE can be shifted by the UE specific arbitrary offset.

Aspects of the present disclosure thus provide solutions for enhanced PDCP discard operation wireless communications, e.g., for multi-modal XR services. For instance, in implementations the network entity configures a set of one or more PDCP discardTimer for a PDPC entity, where each of the set of configured PDCP discardtimer can be applied for a PDCP SDU of a PDU set associated with a predefined criterion. According to one implementation, different PDCP discardTimer configurations are used for different PDU sets of a DRB/PDCP entity being associated with different QoS flows. In one example a mapping between a PDCP discardTimer of a set of one or more PDCP discardTimers and a QFI is configured or specified. In one example NE (e.g., gNB) configures the mapping between QoS flow and PDCP discardTimer configuration for a PDCP entity/radio bearer.

In implementations, a PDCP Tx entity upon arrival of a PDCP SDU (from upper layer (Service Data Adaptation Protocol (SDAP)) can determine based on an identifier of the QoS flow the SDU is associated with (e.g., the QoS flow ID of the SDU/PDU set), the corresponding PDCP discardTimer to be applied for the SDU/PDU set. This determination can in one example be done based on a configured mapping between PDCP discardTimer(s) and associated QFI value. In one example the SDAP indicates the corresponding QFI to the PDCP layer when submitting a PDCP SDU to the PDCP entity. By allowing the usage of different PDCP discardTimer (e.g., PDCP discardTimer configured with different values), the network entity has the option to configure, for example, a larger PDCP discardTimer value for SDUs/PDU sets of QoS flows which have a larger PSDB/PDB. For cases when different modals of a multi-modality XR application are mapped to the same radio bearer (e.g., in order to address the relative synchronization requirements among the different modals), it can be beneficial to use different PDCP discardTimer for SDUs of the different modals with distinct QoS requirements. It is to be noted that a video service may have, for example, different QoS requirements compared to a haptic service such as shown above.

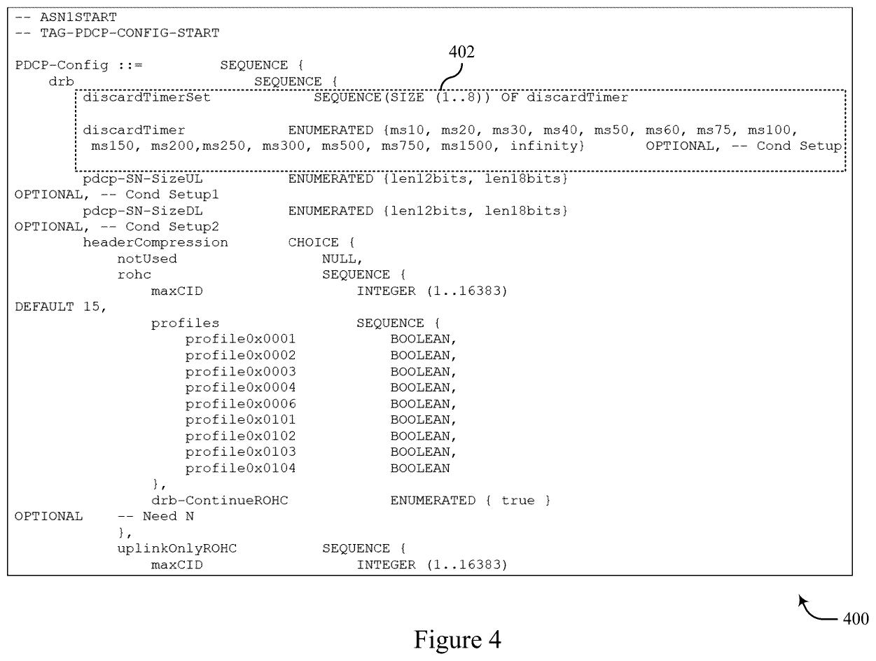

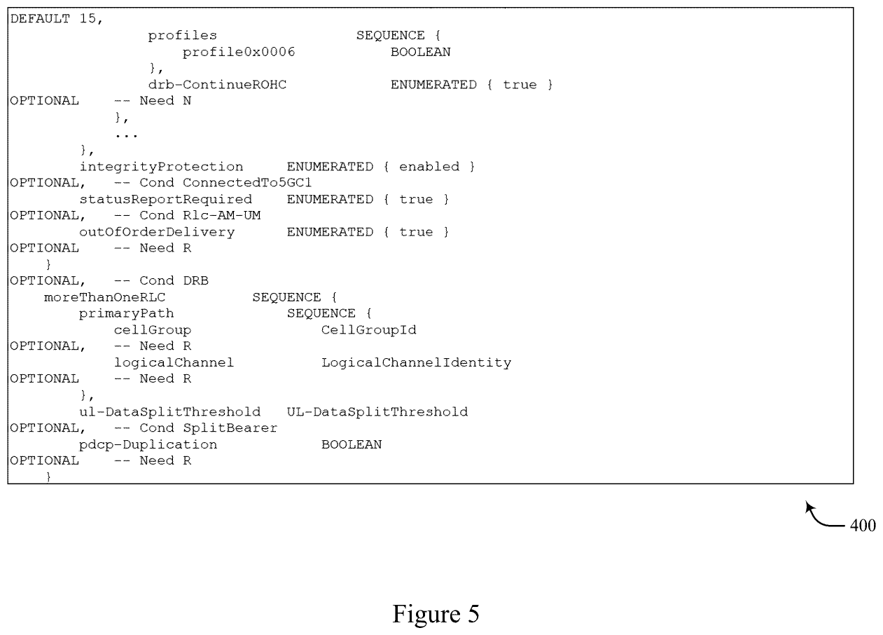

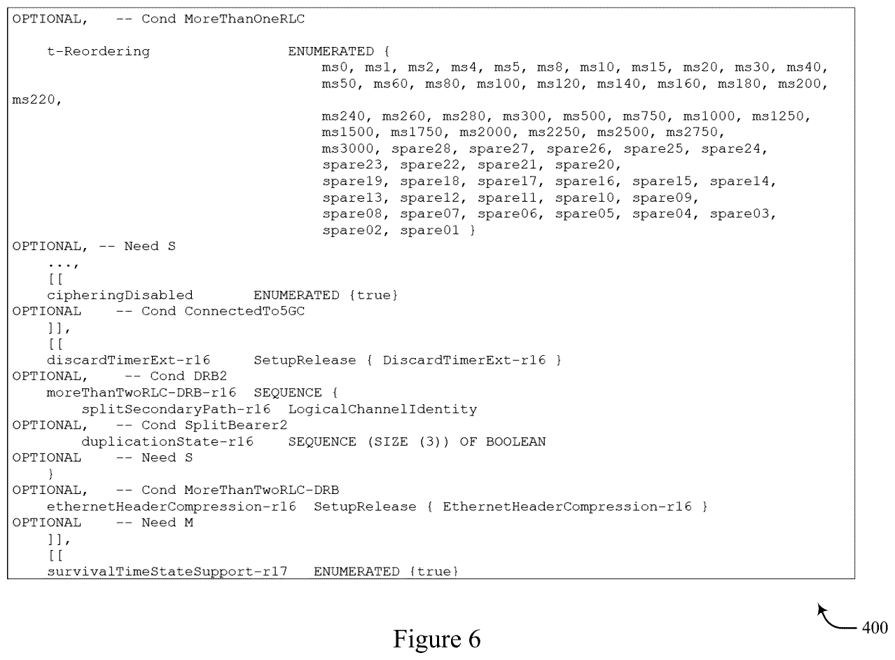

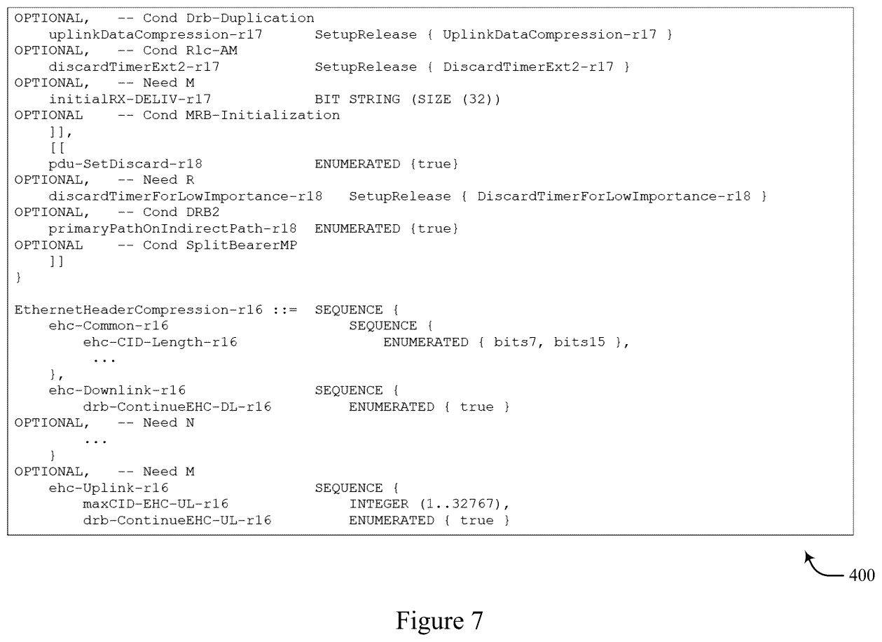

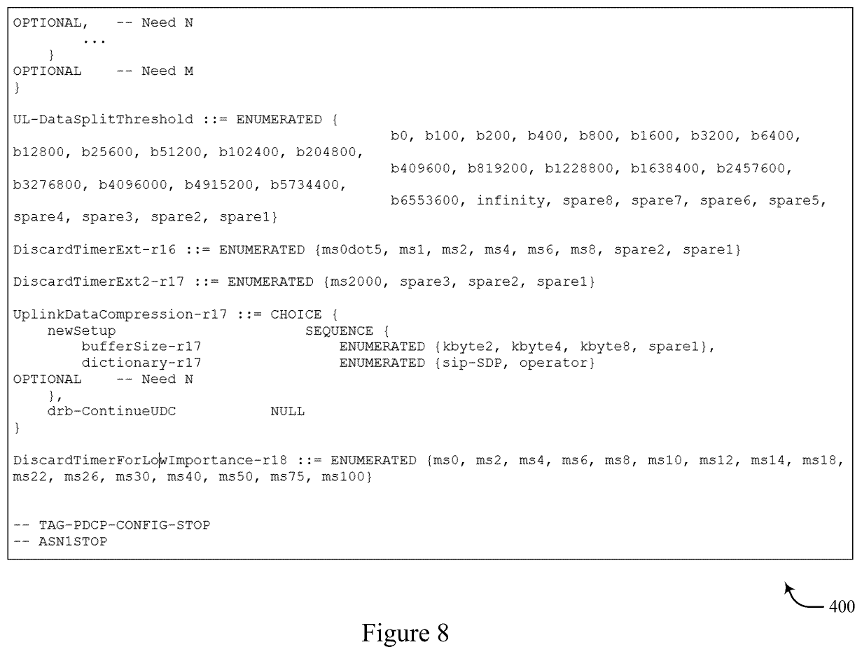

FIGS. 4-8 illustrate an example information element 400 in accordance with aspects of the present disclosure. The example information element 400 is implemented in ASN.1 and includes a field 402 (e.g., PDCP-Config) that can be used to set the configurable PDCP parameters for signalling, multicast broadcast service (MBS) multicast, and data radio bearers.

In implementations, the network entity configures one or more sets of multiple PDCP discardTimer for a PDPC entity, and each of the set of configured PDCP discardtimer can be applied for a PDCP SDU of a PDU set associated with predefined criteria. In an example, for each QoS flow mapped to a radio bearer/PDCP entity, a set of multiple PDCP discardTimer configurations can be configured. In one example a mapping between a set of PDCP discardTimer and a QFI is configured and/or specified. For each QoS flow identified by a QFI, two PDCP discardTimer can be configured, e.g., discardTimer and discardTimerForLowImportance. In one example a NE (e.g., gNB) configures the mapping between QoS flow and set of PDCP discardTimer configuration for a PDCP entity/radio bearer.

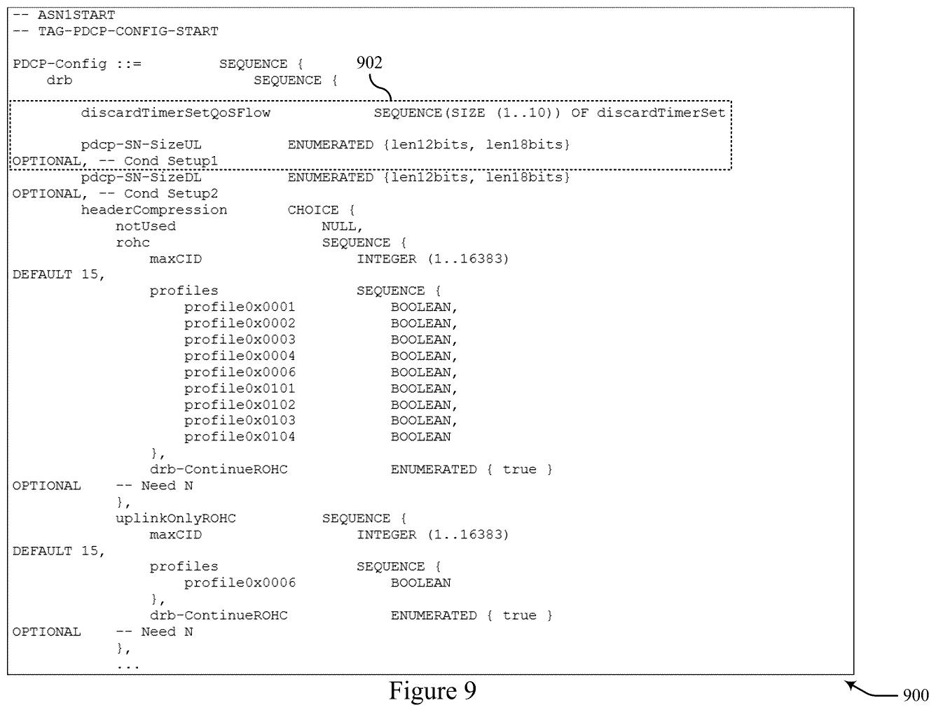

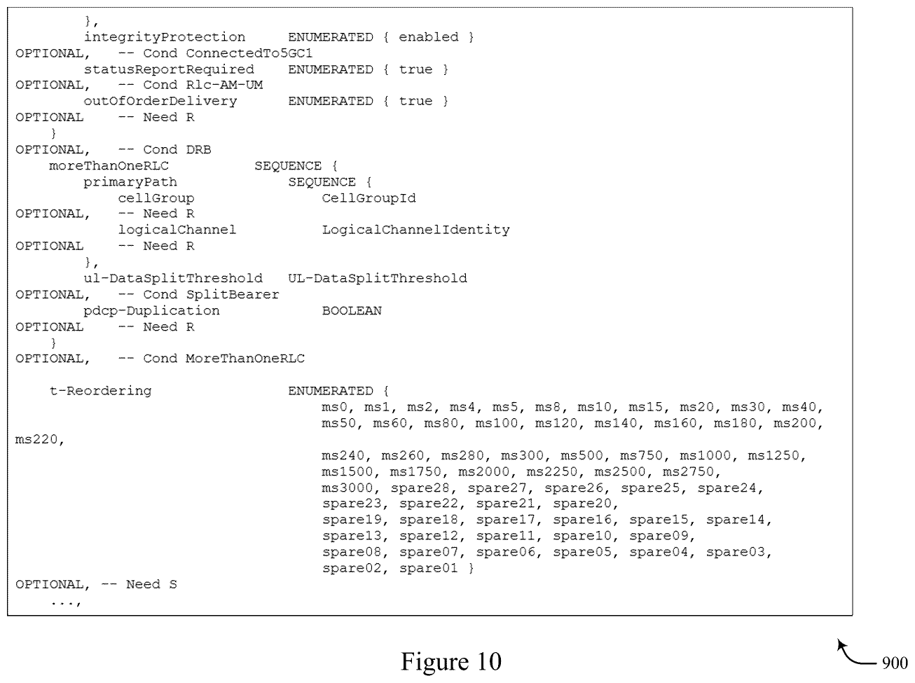

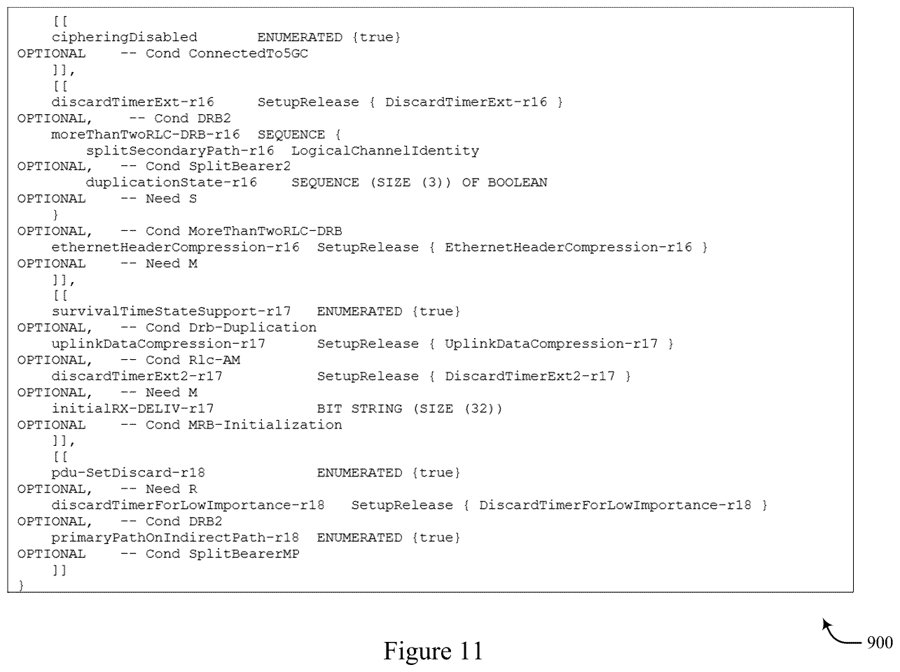

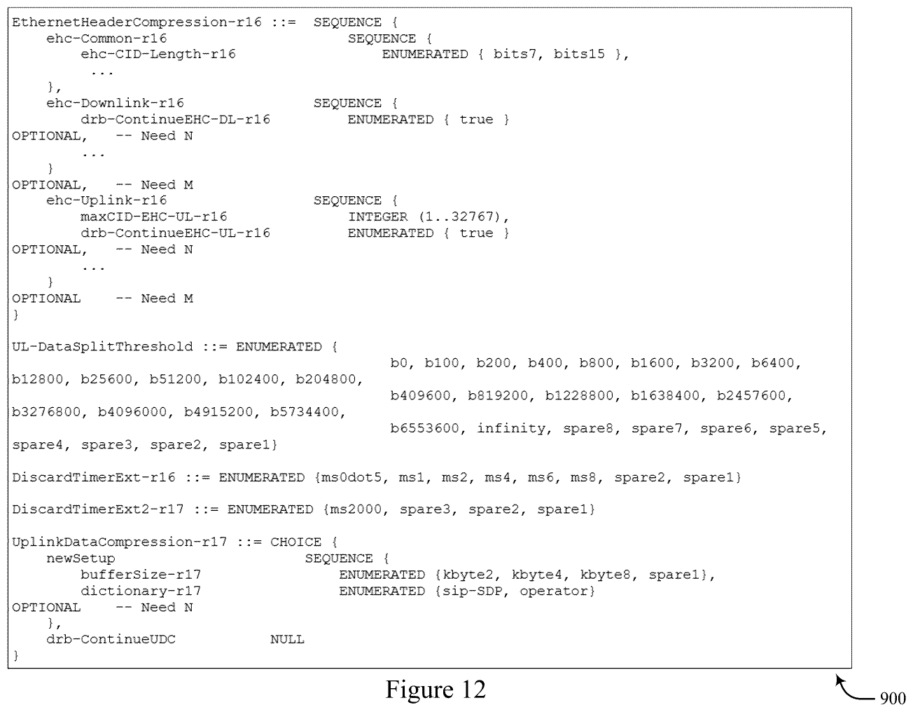

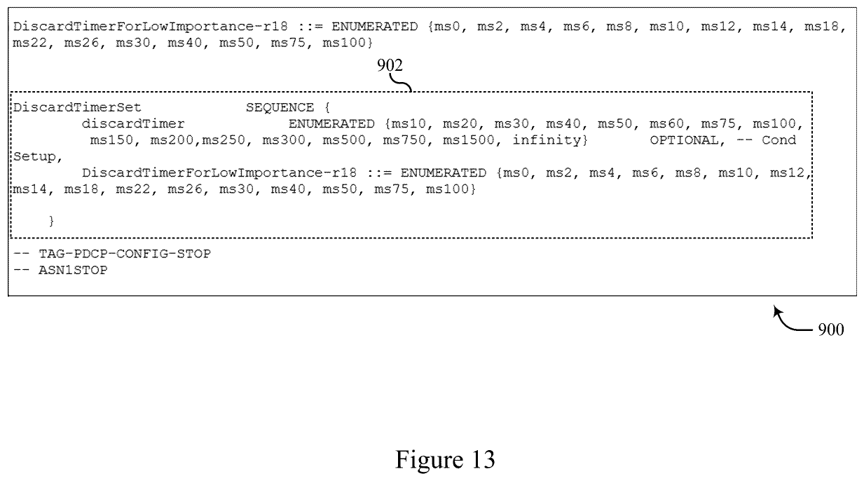

FIGS. 9-13 illustrate an example information element 900 in accordance with aspects of the present disclosure. The example information element 900 is implemented in ASN.1 and includes fields 902 that can be used to set the configurable PDCP parameters for signalling, MBS multicast and data radio bearers.

In implementations, a PDCP Tx entity upon arrival of a PDCP SDU (e.g., from upper layer (e.g., SDAP)) can determine based on an indication the QoS flow the SDU is associated with, e.g. the QoS flow ID of the SDU/PDU set. Subsequently the PDCP Tx entity can determine the corresponding PDCP discardTimer to be applied for the SDU/PDU set based on the determined QoS flow ID and potentially based on the importance level associated with the SDU. In one example the SDAP indicates to the PDCP layer when submitting a PDCP SDU to the PDCP entity the corresponding QFI. For cases when PSI-based discarding is enabled, a PDCP Tx entity can use discardTimerForLowImportance for the low importance SDUs of a QoS flow if configured.

In implementations, a PDCP Tx entity can determine the PDCP discardTimer to be applied for a SDU (upon reception from upper layer) based on PDU set information associated with the SDU. For cases where a network entity configures multiple PDCP discardTimer for a PDCP entity (e.g., multiple QoS flows with distinct QoS requirements are multiplexed on one radio bearer), the PDCP Tx entity can determine the corresponding PDCP discardTimer to be used for a SDU of that radio bearer based on PDU set information provided by upper layer (e.g. application layer). In one example the PSDB value associated with a SDU/PDU set can be used to determine the corresponding PDCP discardTimer configuration to be applied for an incoming SDU. According to one implementation, the PDU set information includes an identifier identifying the corresponding QoS flow or application, e.g. video, audio or haptic data, of an SDU/PDU set. Based on this identifier within the PDU Set information, the PDCP Tx entity can determine the corresponding PDCP discardTimer configuration for a SDU.

In implementations, the network entity can configure in addition to the set of PDCP discardTimer for a PDCP entity as disclosed in the above implementations, an additional timer which can be used to enforce the relative delay/synchronization requirements for multi-modal application. For instance, a UE can start the additional timer upon arrival of a SDU of a PDU set at the PDCP entity in addition to the determined PDCP discardTimer. According to one implementation, the UE has a multi-modal application running consisting of ‘n’ associated traffic flows (referred to as TF1, . . . , TFn), which are mapped to the same radio bearer. In one implementation, PDU sets/PDUs of the associated traffic flows can be inter-dependent, e.g., the inter-dependent PDUs/PDU set(s) of the associated QoS flows can be required to be received/transmitted within a certain time window. Upon arrival of a first SDU/PDU set of the inter-dependent PDUs/PDU sets of the associated QoS flows, the UE can start the additional new timer which can enforce the relative delay budget among the associated flows. For instance, the additional timer (also referred to as MM timer) can enforce the time window during which the inter-dependent PDUs/PDUs of the associated flows are to be transmitted/received.

In implementations there can be one relative multi-modal delay budget for inter-dependent data packets/PDU sets of three associated QoS flows that are to be transmitted/received during the relative delay budget, e.g., time window. At t1 the PDU set (e.g., first SDU of the PDU set) of QoS flow 1 arrives at the PDCP Tx entity. For example, as discussed above, a UE starts the PDCP discard timer configured for QoS flow 1 for the SDU respectively associated PDU set. The new timer according to implementations can be implemented in addition to the started PDCP discard timer, with the new timer being responsible for enforcing the relative multi-modal delay budget.

At t2 the inter-dependent first PDU of the PDU set of QoS flow 2 arrives in the UE buffer at the PDCP Tx entity. A corresponding PDCP discard timer can be started for the PDU/PDU set, such as discussed above. At t3, the related PDU set of QoS flow 3 arrives at the PDCP entity and accordingly the PDCP discard timer can be started for the PDU/PDU set. Upon expiry of the new timer enforcing the multi-modal relative delay requirement at t4, the UE can stop transmitting any remaining transmissions of the inter-dependent PDU sets. For instance, any remaining PDUs of the inter-dependent PDU sets of QoS flow 1, QoS flow 2 or QoS flow 3 pending for transmission can be discarded upon expiry of the new timer. In implementations the new timer can be started upon arrival of the first PDU/PDU set of the inter-dependent PDU sets which can be PDU of PDU set of QoS flow 1, QoS flow 2, or QoS flow 3, such as based on the traffic characteristics and jitter.

In one example, the network entity configures the UE with the MM timer configuration, e.g., the network entity configures for a PDCP entity which carries multiple QoS flows belonging to the same multi-modal application a MM timer. According to another example implementation, the UE sets the MM timer value based on PDU set information received from the application layer. For instance, the application layer informs the access stratum (AS) of the UE about the multi-modal relative delay requirement and UE/PDCP entity determines the MM timer configuration/value accordingly. It is to be noted that the UE may be configured with multiple MM timers for a PDCP entity which can enforce different relative delay/synchronization requirements. As discussed herein, there may be different synchronization requirements between different pairs of modalities, e.g. audio—tactile, video—tactile, etc. Furthermore, there may be different synchronization requirements depending on which media component is delayed compared to the other component of the pair of modalities. A PDCP entity can determine, upon arrival of an SDU/PDU set of a modality, the relative delay/synchronization requirement for the other dependent modalities and sets the MM timer accordingly. In one example a PDCP entity may start multiple MM timers upon arrival of a SDU of a PDU set, each of the MM timer enforcing a different relative delay/synchronization requirement.

In implementations, a PDCP Tx entity can determine a PDCP discard timer value associated with a SDU/PDU by considering a relative delay/synchronization requirement defined between SDUs/PDU sets of other modalities carried via the same PDCP entity. According to one example, the PDCP discard timer value associated with a PDCP PDU/SDU can be a function of the configured discardtimer for the corresponding QoS flow and the current value of a different timer running in the same PDCP entity. When a UE starts a PDCP discard timer for a PDU/PDU set which is part of a set of inter-dependent PDU sets of multi-modal flows, the PDCP discard timer value can be determined as the minimum of the configured PDCP discardtimer value and the current value of the timer enforcing the multi-modal relative delay/synchronization requirement.

In this example there can be three QoS flows which are mapped to one radio bearer. There can be one relative multi-modal delay budget, e.g., inter-dependent data packets/PDU sets of the three associated QoS flows are to be transmitted/received during the relative delay budget (time window). At t1 the PDU set (e.g., first PDU of the PDU set) of QoS flow 1 arrives at the PDCP Tx entity. The UE can determine the configured PDCP discardTimer configuration for QoS flow 1 and start the corresponding PDCP discard timer. A new timer referred to as MM timer in addition to the PDCP discard timer can be started, the MM timer being responsible for enforcing the relative multi-modal delay budget. At t2 the inter-dependent PDU set of QoS flow 2 arrives at the PDCP Tx entity. The corresponding PDCP discardtimer configuration can be determined for QoS flow 2.

However, the PDCP discard timer value can be set taking the current timer value of the MM timer into account. In one example the PDCP discardTimer of QoS flow 2 is set as the minimum of configured PDCP discardTimer for QoS flow 2 and current timer value of the new MM timer. At t3, the inter-dependent PDU set of Qos Flow 3 arrives in PDCP entity. Further, for QoS flow 2, the PDCP discardTimer is set as the minimum of the configured discardtimer for QoS flow 3 and the current value of the MM timer.

According to implementations, the multi-modal relative delay requirement can be enforced by adapting the legacy PDCP discard timer value, e.g., considering the current value of the MM timer when starting the PDCP discard timer. No specific action may need to be performed upon the expiry of the MM timer, since the PDCP discard timer can be enforcing the multi-modal relative delay requirement. For instance, discarding can be performed at the expiry of the PDCP discard timer as in the legacy. It is to be noted that UE may be configured with multiple MM timers for a PDCP entity which enforce different relative delay/synchronization requirements. As discussed herein, there may be different synchronization requirements between different pairs of modalities, e.g. audio-tactile, video-tactile, etc. Furthermore, there may be different synchronization requirements depending on which media component is delayed compared to the other component of the pair of modalities. A PDCP entity may determine, upon arrival of an SDU/PDU set of a modality, the relative delay/synchronization requirement for the other dependent modalities and sets the MM timer. In one example a PDCP entity may start multiple MM timers upon arrival of a SDU (of a PDU set), with each of the MM timers enforcing a different relative delay/synchronization requirement.

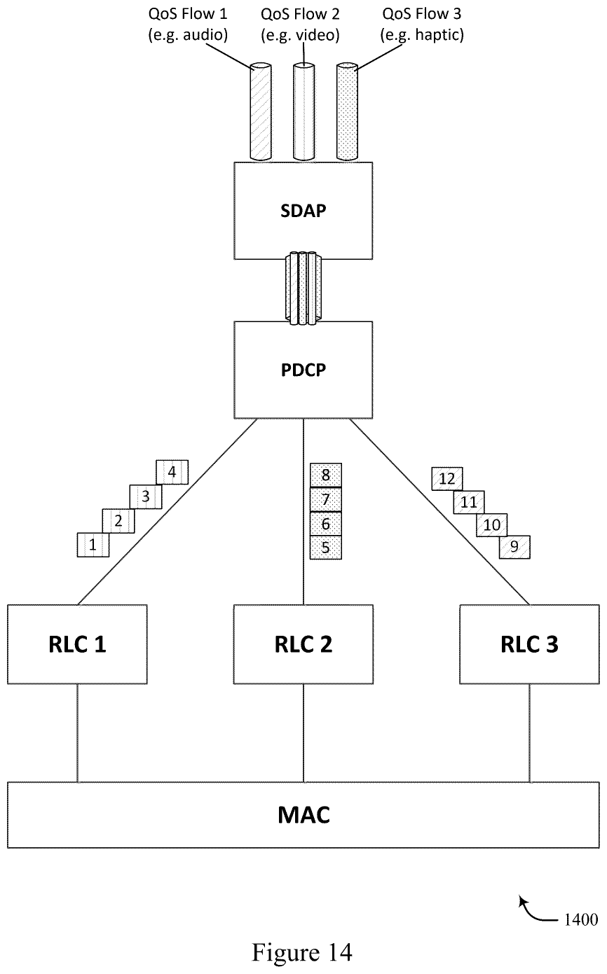

FIG. 14 illustrates a scenario 1400 where different QoS flows are split into different RLC entities in accordance with aspects of the present disclosure. The scenario 1400, for instance, includes RLC entity 1 associated with QoS Flow 2, RLC entity 2 associated with QoS flow 3, and RLC entity 3 associated with QoS flow 1. In implementations, the PDCP Tx layer of a UE performs routing of PDCP PDUs to the associated RLC entities based on an identifier/information associated with a PDCP SDU. For instance, the PDCP layer is associated with multiple RLC entities. In an example the identifier/information used for routing can be the QoS flow ID associated with a PDCP SDU, e.g., data of QoS flows with different QoS requirements are mapped to different RLC entities. In one example, the information based on which the routing of PDCP PDUs is performed (e.g., QoS flow ID) can be provided by SDAP layer to the PDCP entity, e.g., via inter-layer communication. In one example the PDCP layer can be provided with a mapping configuration specifying the mapping between a QoS flow ID and a RLC entity/RLC bearer. In one example the PDCP layer of the UE uses the mapping information for the routing of PDCP PDUs to the associated RLC entities.

In implementations, PDCP control PDUs can be delivered from PDCP layer to the RLC entity having the highest priority LCH for cases that the PDCP entity is associated with multiple RLC entities/LCHs. In another implementation of the embodiment PDCP control PDUs can be carried via any of the LCHs/RLC entities associated with the common PDCP entity.

In implementations, a buffer status report can be triggered based on new data becoming available for transmission that has a higher priority than the priority of other data which is available for transmission. According to one implementation, the priority of the data becoming available for transmission (e.g., arriving in the PDCP entity from upper layer) can be determined based on the QoS flow ID associated with the data. In one example the UE determines the priority of the data based on the mapping between the QoS flow ID of the data, e.g. PDCP SDU and the RLC entity. In one example the priority of the data corresponds to the priority of the LCH to which a PDCP SDU can be routed based on the QoS flow ID associated with the data.

In implementations, when indicating a PDCP data volume to a MAC entity for buffer status report (BSR) triggering and buffer size calculation, a UE can split the data volume of the common PDCP entity among the multiple associated RLC entities in order to compute a data volume per RLC bearer. For instance, a data volume of the RLC bearer can correspond to the sum of the RLC data volume and the amount of the PDCP data volume which is associated to the corresponding RLC entity, such as based on the QoS flow ID associated with a PDCP SDU/PDU and the mapping between QoS flow and RLC entity/bearer/LCH. In a scenario where the PDCP entity is associated with three RLC entities-one for video data, one for audio data, and one for haptic data, the PDCP data volume can split in 3 parts. For instance, one part corresponding to the video PDCP SDUs/PDUs, one part for audio PDCP SDUs/PDUs, and one part accounting for the haptic PDCP SDUs/PDUs.

In implementations to provide information to the NE (e.g., gNB) for efficient scheduling, the NE is to have information for the amount of data available for transmission for each of the multiple LCHs/RLC entities which are associated with the PDCP entity. For cases where the different LCHs which are associated with the common PDCP entity are mapped to different LCGs, a current buffer status MAC CE format can indicate the buffer status per importance level, e.g., given that the PDCP data volume is split/shared among the different RLC entities/bearers as described above.

In implementations, a receiving PDCP entity determines the RLC entity from which a PDCP PDU was delivered to the PDCP entity when determining when to deliver the corresponding PDCP PDU/SDU to upper layer. According to one implementation, a Rx PDCP entity determines based on the RLC entity used for the transmission of an PDCP PDU/SDU the packet delay budget/reordering time of the corresponding PDU/SDU. For cases when a PDCP entity is associated with multiple RLC entities and the different RLC entities are used for transmission of data with different QoS requirements (e.g., PSDB/PDB), the receiving PDCP entity can determine the QoS requirement of a PDU/SDU, e.g., based on the RLC entity the PDU/SDU was received on. For example, the PDCP entity may deliver PDUs/SDUs with a shorter PSDB/PDB earlier to higher layer compared to PDU/SDUs (e.g., PDUs/SDUs being stored in the receiving buffer) with a larger PSDB/PDB. According to some current specified behaviors, each packet within a PDCP receiving buffer/entity can be treated the same with respect to the timing of delivery to higher layer, e.g., one reordering timer is utilized.

However, in cases where different modals are mapped to one radio bearer, there can be packets with different delay requirements within a radio bearer. Accordingly, distinguished treatment of PDUs/SDUs considering their distinct delay requirements at the PDCP receive (RX) entity (e.g., when performing reordering) can be beneficial. In one example there are multiple reordering timers used for a PDCP Rx entity, e.g., for each RLC entity associated with the PDCP entity a separate reordering timer can be configured. In one example a mapping between RLC entity and reordering timer configuration can be configured for the PDCP Rx entity. According to one implementation, the PDCP entity can determine the reordering timer configuration (t-Reordering) to be used based on the RLC entity the PDCP Data PDU that triggered t-Reordering was received on.

In implementations, a receiving PDCP entity can consider the QoS flow ID of the data contained in a PDCP PDU when determining when to deliver the corresponding PDCP PDU/SDU to upper layer from the receiving buffer. For cases where different QoS flows in which different QoS delay requirements are mapped to the same DRB and LCH/RLC entity, the PDCP Rx entity can consider the QoS flow ID of the data contained in a PDCP PDU in order to determine the reordering timer, e.g., t-Reordering. In one example a PDCP entity can be configured with multiple t-Reordering timer configurations. In an example a mapping between t-Reordering timer configuration and QoS flow ID can be configured for a PDCP (RX) entity.

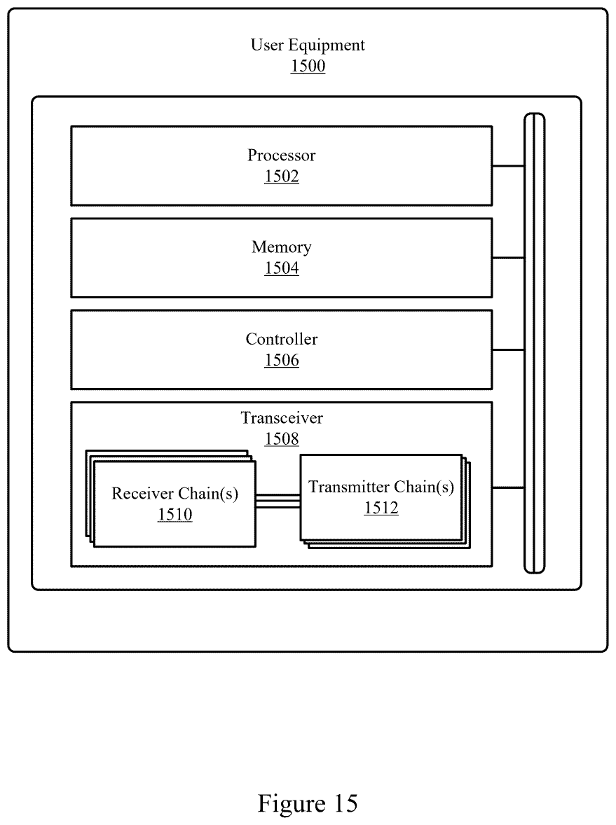

FIG. 15 illustrates an example of a UE 1500 in accordance with aspects of the present disclosure. The UE 1500 may include a processor 1502, a memory 1504, a controller 1506, and a transceiver 1508. The processor 1502, the memory 1504, the controller 1506, or the transceiver 1508, or various combinations thereof or various components thereof may be examples of means for performing various aspects of the present disclosure as described herein. These components may be coupled (e.g., operatively, communicatively, functionally, electronically, electrically) via one or more interfaces.

The processor 1502, the memory 1504, the controller 1506, or the transceiver 1508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1502 may include an intelligent hardware device (e.g., a general-purpose processor, a DSP, a CPU, an ASIC, an FPGA, or any combination thereof). In some implementations, the processor 1502 may be configured to operate the memory 1504. In some other implementations, the memory 1504 may be integrated into the processor 1502. The processor 1502 may be configured to execute computer-readable instructions stored in the memory 1504 to cause the UE 1500 to perform various functions of the present disclosure.

The memory 1504 may include volatile or non-volatile memory. The memory 1504 may store computer-readable, computer-executable code including instructions when executed by the processor 1502 cause the UE 1500 to perform various functions described herein. The code may be stored in a non-transitory computer-readable medium such as the memory 1504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1502 and the memory 1504 coupled with the processor 1502 may be configured to cause the UE 1500 to perform one or more of the functions described herein (e.g., executing, by the processor 1502, instructions stored in the memory 1504). For example, the processor 1502 may support wireless communication at the UE 1500 in accordance with examples as disclosed herein. The UE 1500 may be configured to or operable to support a means for receiving a configuration for a PDCP entity of the UE, wherein the configuration includes a set of timer configurations and a set of identifiers associated with the set of timer configurations; receiving a SDU at the PDCP entity of the UE; and starting a timer associated with the PDCP entity of the UE and in accordance with a timer configuration, wherein the timer configuration is applicable for the received SDU based at least in part on a corresponding identifier of the timer configuration and a respective identifier the received SDU.

Additionally, the UE 1500 may be configured to support any one or combination of receiving the configuration from a radio access network (RAN); selecting the timer configuration based at least in part on a mapping between the corresponding identifier of the timer configuration and the respective identifier the received SDU; wherein a value for the timer is based at least in part on the selected timer configuration; wherein the set of identifiers includes a set of QoS flow identifiers; starting the timer in response to the received SDU; wherein the timer includes a PDCP discard timer; wherein the respective identifier of the received SDU includes a QoS flow identifier of a QoS flow associated with the received SDU; wherein each timer configuration of the set of timer configurations is associated with a respective QoS flow; wherein the timer configuration is applicable for the received SDU further based at least in part on a priority associated with the received SDU; wherein the set of identifiers is associated with a set of radio link control (RLC) entities of the UE associated with the PDCP entity, and wherein the method further includes routing a PDU associated with the received SDU to a respective RLC entity of the UE based at least in part on a respective identifier associated with the respective RLC entity and the respective identifier associated with the received SDU.

Additionally, or alternatively, the UE 1500 may support at least one memory (e.g., the memory 1504) and at least one processor (e.g., the processor 1502) coupled with the at least one memory and configured to cause the UE to receive a configuration for a PDCP entity of the UE, wherein the configuration includes a set of timer configurations and a set of identifiers associated with the set of timer configurations; receive a SDU at the PDCP entity of the UE; and start a timer associated with the PDCP entity of the UE and in accordance with a timer configuration, wherein the timer configuration is applicable for the received SDU based at least in part on a corresponding identifier of the timer configuration and a respective identifier the received SDU.

Additionally, the UE 1500 may be configured to support any one or combination of where the at least one processor is configured to cause the UE to receive the configuration from a radio access network (RAN); the at least one processor is configured to cause the UE to select the timer configuration based at least in part on a mapping between the corresponding identifier of the timer configuration and the respective identifier the received SDU; a value for the timer is based at least in part on the selected timer configuration; the set of identifiers includes a set of QoS flow identifiers; the at least one processor is configured to cause the UE to start the timer in response to the received SDU; the timer includes a PDCP discard timer; the respective identifier of the received SDU includes a QoS flow identifier of a QoS flow associated with the received SDU; each timer configuration of the set of timer configurations is associated with a respective QoS flow; the timer configuration is applicable for the received SDU further based at least in part on a priority associated with the received SDU; the set of identifiers is associated with a set of radio link control (RLC) entities of the UE associated with the PDCP entity, and wherein the at least one processor is configured to cause the UE to: route a PDU associated with the received SDU to a respective RLC entity of the UE based at least in part on a respective identifier associated with the respective RLC entity and the respective identifier associated with the received SDU.

The controller 1506 may manage input and output signals for the UE 1500. The controller 1506 may also manage peripherals not integrated into the UE 1500. In some implementations, the controller 1506 may utilize an operating system such as iOS®, ANDROID®, WINDOWS®, or other operating systems. In some implementations, the controller 1506 may be implemented as part of the processor 1502.

In some implementations, the UE 1500 may include at least one transceiver 1508. In some other implementations, the UE 1500 may have more than one transceiver 1508. The transceiver 1508 may represent a wireless transceiver. The transceiver 1508 may include one or more receiver chains 1510, one or more transmitter chains 1512, or a combination thereof.

A receiver chain 1510 may be configured to receive signals (e.g., control information, data, packets) over a wireless medium. For example, the receiver chain 1510 may include one or more antennas to receive a signal over the air or wireless medium. The receiver chain 1510 may include at least one amplifier (e.g., a low-noise amplifier (LNA)) configured to amplify the received signal. The receiver chain 1510 may include at least one demodulator configured to demodulate the receive signal and obtain the transmitted data by reversing the modulation technique applied during transmission of the signal. The receiver chain 1510 may include at least one decoder for decoding the demodulated signal to receive the transmitted data.

A transmitter chain 1512 may be configured to generate and transmit signals (e.g., control information, data, packets). The transmitter chain 1512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1512 may also include at least one power amplifier configured to amplify the modulated signal to an appropriate power level suitable for transmission over the wireless medium. The transmitter chain 1512 may also include one or more antennas for transmitting the amplified signal into the air or wireless medium.

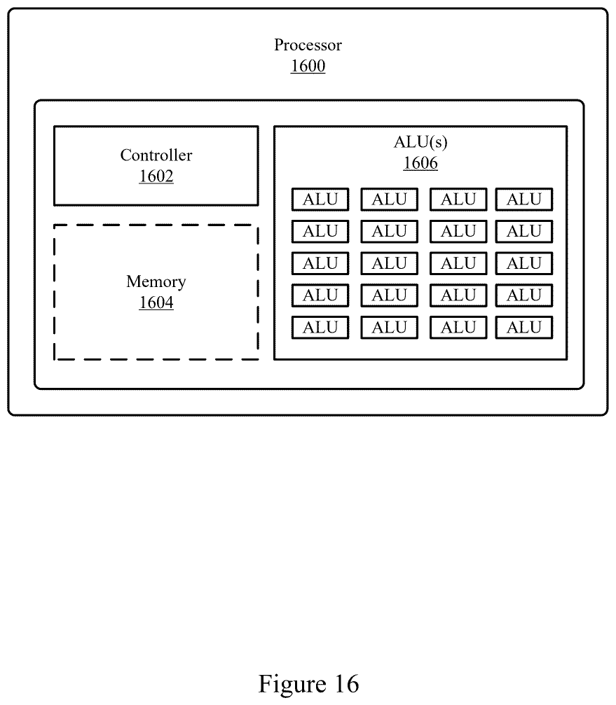

FIG. 16 illustrates an example of a processor 1600 in accordance with aspects of the present disclosure. The processor 1600 may be an example of a processor configured to perform various operations in accordance with examples as described herein. The processor 1600 may include a controller 1602 configured to perform various operations in accordance with examples as described herein. The processor 1600 may optionally include at least one memory 1604, which may be, for example, an L1/L2/L3 cache. Additionally, or alternatively, the processor 1600 may optionally include one or more arithmetic-logic units (ALUs) 1606. One or more of these components may be in electronic communication or otherwise coupled (e.g., operatively, communicatively, functionally, electronically, electrically) via one or more interfaces (e.g., buses).

The processor 1600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1602 may be configured to manage and coordinate various operations (e.g., signaling, receiving, obtaining, retrieving, transmitting, outputting, forwarding, storing, determining, identifying, accessing, writing, reading) of the processor 1600 to cause the processor 1600 to support various operations in accordance with examples as described herein. For example, the controller 1602 may operate as a control unit of the processor 1600, generating control signals that manage the operation of various components of the processor 1600. These control signals include enabling or disabling functional units, selecting data paths, initiating memory access, and coordinating timing of operations.

The controller 1602 may be configured to fetch (e.g., obtain, retrieve, receive) instructions from the memory 1604 and determine subsequent instruction(s) to be executed to cause the processor 1600 to support various operations in accordance with examples as described herein. The controller 1602 may be configured to track memory addresses of instructions associated with the memory 1604. The controller 1602 may be configured to decode instructions to determine the operation to be performed and the operands involved. For example, the controller 1602 may be configured to interpret the instruction and determine control signals to be output to other components of the processor 1600 to cause the processor 1600 to support various operations in accordance with examples as described herein. Additionally, or alternatively, the controller 1602 may be configured to manage flow of data within the processor 1600. The controller 1602 may be configured to control transfer of data between registers, ALUs 1606, and other functional units of the processor 1600.

The memory 1604 may include one or more caches (e.g., memory local to or included in the processor 1600 or other memory, such as RAM, ROM, DRAM, SDRAM, SRAM, MRAM, flash memory, etc. In some implementations, the memory 1604 may reside within or on a processor chipset (e.g., local to the processor 1600). In some other implementations, the memory 1604 may reside external to the processor chipset (e.g., remote to the processor 1600).

The memory 1604 may store computer-readable, computer-executable code including instructions that, when executed by the processor 1600, cause the processor 1600 to perform various functions described herein. The code may be stored in a non-transitory computer-readable medium such as system memory or another type of memory. The controller 1602 and/or the processor 1600 may be configured to execute computer-readable instructions stored in the memory 1604 to cause the processor 1600 to perform various functions. For example, the processor 1600 and/or the controller 1602 may be coupled with or to the memory 1604, the processor 1600, and the controller 1602, and may be configured to perform various functions described herein. In some examples, the processor 1600 may include multiple processors and the memory 1604 may include multiple memories. One or more of the multiple processors may be coupled with one or more of the multiple memories, which may, individually or collectively, be configured to perform various functions herein.

The one or more ALUs 1606 may be configured to support various operations in accordance with examples as described herein. In some implementations, the one or more ALUs 1606 may reside within or on a processor chipset (e.g., the processor 1600). In some other implementations, the one or more ALUs 1606 may reside external to the processor chipset (e.g., the processor 1600). One or more ALUs 1606 may perform one or more computations such as addition, subtraction, multiplication, and division on data. For example, one or more ALUs 1606 may receive input operands and an operation code, which determines an operation to be executed. One or more ALUs 1606 may be configured with a variety of logical and arithmetic circuits, including adders, subtractors, shifters, and logic gates, to process and manipulate the data according to the operation. Additionally, or alternatively, the one or more ALUs 1606 may support logical operations such as AND, OR, exclusive-OR (XOR), not-OR (NOR), and not-AND (NAND), enabling the one or more ALUs 1606 to handle conditional operations, comparisons, and bitwise operations.

The processor 1600 may support wireless communication in accordance with examples as disclosed herein. The processor 1600 may be configured to or operable to support at least one controller (e.g., the controller 1602) coupled with at least one memory (e.g., the memory 1604) and configured to cause the processor to receive a configuration for a PDCP entity of a UE, wherein the configuration includes a set of timer configurations and a set of identifiers associated with the set of timer configurations; receive a SDU at the PDCP entity of the UE; and start a timer associated with the PDCP entity of the UE and in accordance with a timer configuration, wherein the timer configuration is applicable for the received SDU based at least in part on a corresponding identifier of the timer configuration and a respective identifier the received SDU.

Additionally, the processor 1600 may be configured to or operable to support any one or combination of where the at least one controller is configured to cause the processor to receive the configuration from a radio access network (RAN); the at least one controller is configured to cause the processor to select the timer configuration based at least in part on a mapping between the corresponding identifier of the timer configuration and the respective identifier the received SDU; a value for the timer is based at least in part on the selected timer configuration; the set of identifiers includes a set of QoS flow identifiers; the at least one controller is configured to cause the processor to start the timer in response to the received SDU; the timer includes a PDCP discard timer; the respective identifier of the received SDU includes a QoS flow identifier of a QoS flow associated with the received SDU; each timer configuration of the set of timer configurations is associated with a respective QoS flow; the timer configuration is applicable for the received SDU further based at least in part on a priority associated with the received SDU; the set of identifiers is associated with a set of radio link control (RLC) entities of the UE associated with the PDCP entity, and wherein the at least one controller is configured to cause the processor to: route a PDU associated with the received SDU to a respective RLC entity of the UE based at least in part on a respective identifier associated with the respective RLC entity and the respective identifier associated with the received SDU.

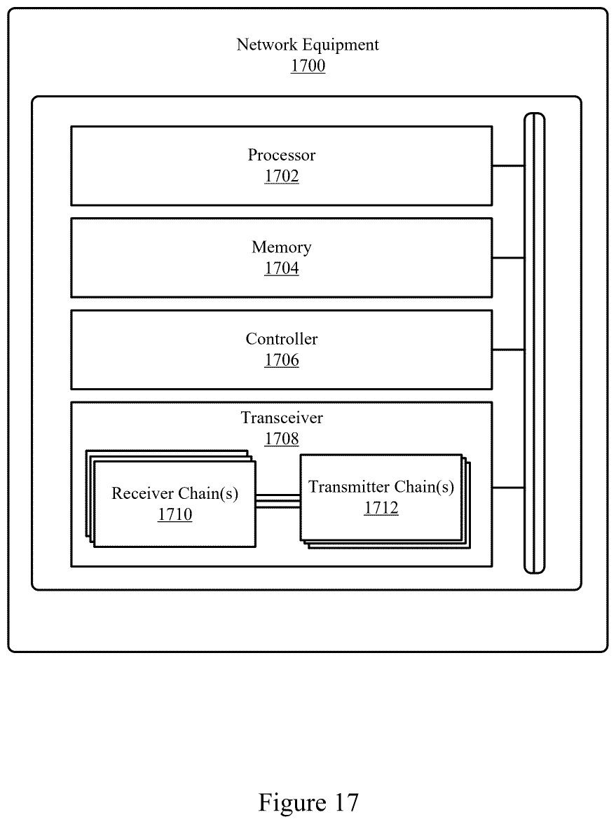

FIG. 17 illustrates an example of a NE 1700 in accordance with aspects of the present disclosure. The NE 1700 may include a processor 1702, a memory 1704, a controller 1706, and a transceiver 1708. The processor 1702, the memory 1704, the controller 1706, or the transceiver 1708, or various combinations thereof or various components thereof may be examples of means for performing various aspects of the present disclosure as described herein. These components may be coupled (e.g., operatively, communicatively, functionally, electronically, electrically) via one or more interfaces.

The processor 1702, the memory 1704, the controller 1706, or the transceiver 1708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1702 may include an intelligent hardware device (e.g., a general-purpose processor, a DSP, a CPU, an ASIC, an FPGA, or any combination thereof). In some implementations, the processor 1702 may be configured to operate the memory 1704. In some other implementations, the memory 1704 may be integrated into the processor 1702. The processor 1702 may be configured to execute computer-readable instructions stored in the memory 1704 to cause the NE 1700 to perform various functions of the present disclosure.

The memory 1704 may include volatile or non-volatile memory. The memory 1704 may store computer-readable, computer-executable code including instructions when executed by the processor 1702 cause the NE 1700 to perform various functions described herein. The code may be stored in a non-transitory computer-readable medium such as the memory 1704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1702 and the memory 1704 coupled with the processor 1702 may be configured to cause the NE 1700 to perform one or more of the functions described herein (e.g., executing, by the processor 1702, instructions stored in the memory 1704). For example, the processor 1702 may support wireless communication at the NE 1700 in accordance with examples as disclosed herein. The NE 1700 may be configured to or operable to support a means for transmitting a configuration for a PDCP entity of a UE, wherein the configuration includes a set of timer configurations and a set of identifiers associated with the set of timer configurations.

Additionally, the NE 1700 may be configured to or operable to support any one or combination of where the configuration further includes a mapping between each timer configuration and each different respective identifier of the set of identifiers; the set of identifiers includes quality of service flow identifiers; each timer configuration of the set of timer configurations is associated with a respective timer value; one or more timer configurations of the set of timer configurations include PDCP discard timer configurations; each timer configuration of the set of timer configurations is associated with a different respective quality of service flow; the configuration further includes importance level information for each timer configuration of the set of timer configurations.

Additionally, or alternatively, the NE 1700 may support at least one memory (e.g., the memory 1704) and at least one processor (e.g., the processor 1702) coupled with the at least one memory and configured to cause the NE to transmit a configuration for a PDCP entity of a UE, wherein the configuration includes a set of timer configurations and a set of identifiers associated with the set of timer configurations.

Additionally, the NE 1700 may be configured to support any one or combination of where the configuration further includes a mapping between each timer configuration and each different respective identifier of the set of identifiers; the set of identifiers includes quality of service flow identifiers; each timer configuration of the set of timer configurations is associated with a respective timer value; one or more timer configurations of the set of timer configurations include PDCP discard timer configurations; each timer configuration of the set of timer configurations is associated with a different respective quality of service flow; the configuration further includes importance level information for each timer configuration of the set of timer configurations.

The controller 1706 may manage input and output signals for the NE 1700. The controller 1706 may also manage peripherals not integrated into the NE 1700. In some implementations, the controller 1706 may utilize an operating system such as iOS®, ANDROID®, WINDOWS®, or other operating systems. In some implementations, the controller 1706 may be implemented as part of the processor 1702.

In some implementations, the NE 1700 may include at least one transceiver 1708. In some other implementations, the NE 1700 may have more than one transceiver 1708. The transceiver 1708 may represent a wireless transceiver. The transceiver 1708 may include one or more receiver chains 1710, one or more transmitter chains 1712, or a combination thereof.

A receiver chain 1710 may be configured to receive signals (e.g., control information, data, packets) over a wireless medium. For example, the receiver chain 1710 may include one or more antennas to receive a signal over the air or wireless medium. The receiver chain 1710 may include at least one amplifier (e.g., a low-noise amplifier (LNA)) configured to amplify the received signal. The receiver chain 1710 may include at least one demodulator configured to demodulate the receive signal and obtain the transmitted data by reversing the modulation technique applied during transmission of the signal. The receiver chain 1710 may include at least one decoder for decoding the demodulated signal to receive the transmitted data.

A transmitter chain 1712 may be configured to generate and transmit signals (e.g., control information, data, packets). The transmitter chain 1712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1712 may also include at least one power amplifier configured to amplify the modulated signal to an appropriate power level suitable for transmission over the wireless medium. The transmitter chain 1712 may also include one or more antennas for transmitting the amplified signal into the air or wireless medium.

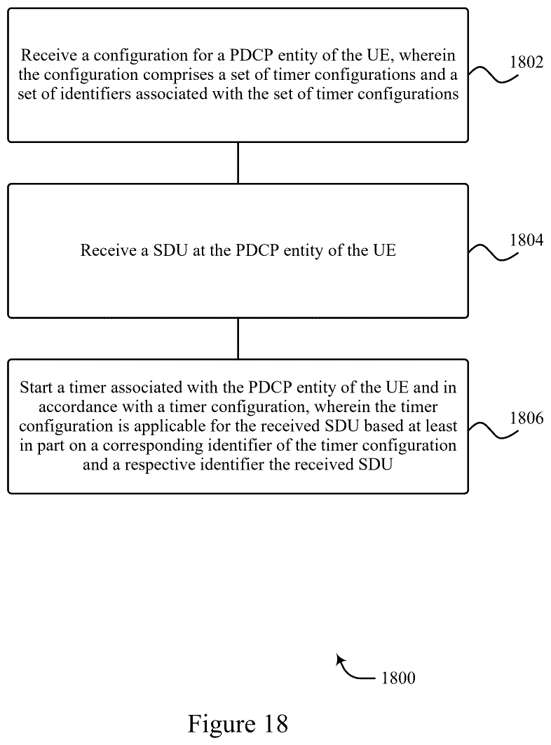

FIG. 18 illustrates a flowchart of a method 1800 in accordance with aspects of the present disclosure. The operations of the method may be implemented by a UE as described herein. In some implementations, the UE may execute a set of instructions to control the function elements of the UE to perform the described functions. It is to be noted that the method described herein describes a possible implementation, and that the operations and the steps may be rearranged or otherwise modified and that other implementations are possible.

At 1802, the method may include receiving a configuration for a PDCP entity of the UE, wherein the configuration comprises a set of timer configurations and a set of identifiers associated with the set of timer configurations. The operations of 1802 may be performed in accordance with examples as described herein. In some implementations, aspects of the operations of 1802 may be performed by a UE as described with reference to FIG. 15.

At 1804, the method may include receiving a SDU at the PDCP entity of the UE. The operations of 1804 may be performed in accordance with examples as described herein. In some implementations, aspects of the operations of 1804 may be performed by a UE as described with reference to FIG. 15.

At 1806, the method may include starting a timer associated with the PDCP entity of the UE and in accordance with a timer configuration, wherein the timer configuration is applicable for the received SDU based at least in part on a corresponding identifier of the timer configuration and a respective identifier the received SDU. The operations of 1806 may be performed in accordance with examples as described herein. In some implementations, aspects of the operations of 1806 may be performed a UE as described with reference to FIG. 15.

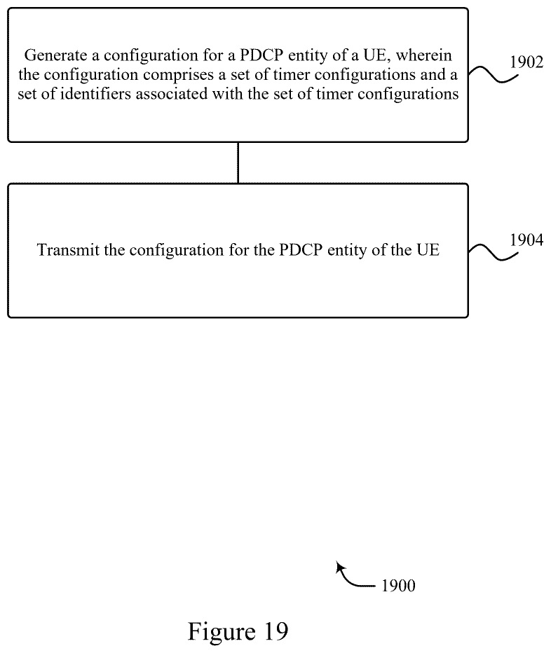

FIG. 19 illustrates a flowchart of a method 1900 in accordance with aspects of the present disclosure. The operations of the method may be implemented by a NE as described herein. In some implementations, the NE may execute a set of instructions to control the function elements of the NE to perform the described functions. It is to be noted that the method described herein describes a possible implementation, and that the operations and the steps may be rearranged or otherwise modified and that other implementations are possible.

At 1902, the method may include generating a configuration for a PDCP entity of a UE, wherein the configuration comprises a set of timer configurations and a set of identifiers associated with the set of timer configurations. The operations of 1902 may be performed in accordance with examples as described herein. In some implementations, aspects of the operations of 1902 may be performed by a NE as described with reference to FIG. 17.

At 1904, the method may include transmitting the configuration for the PDCP entity of the UE. The operations of 1904 may be performed in accordance with examples as described herein. In some implementations, aspects of the operations of 1904 may be performed by a NE as described with reference to FIG. 17.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration for a packet data convergence protocol (PDCP) entity of the UE, wherein the configuration comprises a set of timer configurations and a set of identifiers associated with the set of timer configurations;
receive a service data unit (SDU) at the PDCP entity of the UE; and
start a timer associated with the PDCP entity of the UE and in accordance with a timer configuration, wherein the timer configuration is applicable for the received SDU based at least in part on a corresponding identifier of the timer configuration and a respective identifier the received SDU.

2. The UE of claim 1, wherein the at least one processor is configured to cause the UE to receive the configuration from a radio access network (RAN).

3. The UE of claim 1, wherein the at least one processor is configured to cause the UE to select the timer configuration based at least in part on a mapping between the corresponding identifier of the timer configuration and the respective identifier the received SDU.

4. The UE of claim 3, wherein a value for the timer is based at least in part on the selected timer configuration.

5. The UE of claim 1, wherein the set of identifiers comprises a set of quality of service (QoS) flow identifiers.

6. The UE of claim 1, wherein the at least one processor is configured to cause the UE to start the timer in response to the received SDU.

7. The UE of claim 1, wherein the timer comprises a PDCP discard timer.

8. The UE of claim 1, wherein the respective identifier of the received SDU comprises a quality of service (QoS) flow identifier of a QoS flow associated with the received SDU.

9. The UE of claim 1, wherein each timer configuration of the set of timer configurations is associated with a respective quality of service (QoS) flow.

10. The UE of claim 1, wherein the timer configuration is applicable for the received SDU further based at least in part on a priority associated with the received SDU.

11. The UE of claim 1, wherein the set of identifiers is associated with a set of radio link control (RLC) entities of the UE associated with the PDCP entity, and wherein the at least one processor is configured to cause the UE to:
route a protocol data unit (PDU) associated with the received SDU to a respective RLC entity of the UE based at least in part on a respective identifier associated with the respective RLC entity and the respective identifier associated with the received SDU.

12. A processor for wireless communication, comprising:
at least one controller coupled with at least one memory and configured to cause the processor to:
receive a configuration for a packet data convergence protocol (PDCP) entity of a user equipment (UE), wherein the configuration comprises a set of timer configurations and a set of identifiers associated with the set of timer configurations;
receive a service data unit (SDU) at the PDCP entity of the UE; and
start a timer associated with the PDCP entity of the UE and in accordance with a timer configuration, wherein the timer configuration is applicable for the received SDU based at least in part on a corresponding identifier of the timer configuration and a respective identifier the received SDU.

13. A network equipment for wireless communication, comprising:
at least one memory; and
at least one processor coupled with the at least one memory and configured to cause the network equipment to:
transmit a configuration for a packet data convergence protocol (PDCP) entity of a user equipment (UE), wherein the configuration comprises a set of timer configurations and a set of identifiers associated with the set of timer configurations.

14. The network equipment of claim 13, wherein the configuration further comprises a mapping between each timer configuration and each different respective identifier of the set of identifiers.

15. The network equipment of claim 13, wherein the set of identifiers comprises quality of service flow identifiers.

16. The network equipment of claim 13, wherein each timer configuration of the set of timer configurations is associated with a respective timer value.

17. The network equipment of claim 13, wherein one or more timer configurations of the set of timer configurations comprise PDCP discard timer configurations.

18. The network equipment of claim 13, wherein each timer configuration of the set of timer configurations is associated with a different respective quality of service flow.

19. The network equipment of claim 13, wherein the configuration further comprises importance level information for each timer configuration of the set of timer configurations.

20. A method performed by a user equipment (UE), the method comprising:
receiving a configuration for a packet data convergence protocol (PDCP) entity of the UE, wherein the configuration comprises a set of timer configurations and a set of identifiers associated with the set of timer configurations;
receiving a service data unit (SDU) at the PDCP entity of the UE; and
starting a timer associated with the PDCP entity of the UE and in accordance with a timer configuration, wherein the timer configuration is applicable for the received SDU based at least in part on a corresponding identifier of the timer configuration and a respective identifier the received SDU.
